(19) United States
(12) Patent Application Publication
(10) Pub. No.: US 2024/0065190 A1
(43) Pub. Date: Feb. 29, 2024

(54) PLANT WATERING GLOBE SYSTEM

(71) Applicant: Blaike Kohlmeyer, Las Vegas, NV (US)

(72) Inventor: Blaike Kohlmeyer, Las Vegas, NV (US)

(21) Appl. No.: 17/893,187

(22) Filed: Aug. 23, 2022

(51) Int. Cl. A01G 27/00

(52) U.S. Cl. CPC A01G 27/006

(57) ABSTRACT

A plant watering globe system; the plant watering globe system includes a hollow bulb portion configured to provide a refillable water reservoir. The hollow bulb portion features an aperture positioned at a top-section and a hollow stake in fluid communication with and extending from a bottom-section of the hollow bulb portion. The hollow stake includes an open-end configured to be inserted in soil of a host plant pot for delivery of water from the hollow bulb portion. A funnel is further provided for refilling the hollow bulb portion with water via the aperture. Additionally, a sealing plug is included for sealing the aperture of the hollow bulb portion.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of gardening and plant maintenance of existing art and more specifically relates to plant watering devices.

### RELATED ART

It is often desirable to dispense a relatively constant volume of liquid, either continuously or at periodic time intervals. For example, typical applications requiring liquid to be dispensed in a controlled fashion include plant feeding or watering. Plants are normally watered in flower boxes, flower pots and the like by the simple process of pouring water directly onto the top of the soil. Additionally, it is known to provide a device for watering the root system of plants and flowers by inserting a perforated, tubular member into the subsoil. Water poured into the top of the known device flows down this member directly towards the root system rather than collecting at the caked upper surface of the soil, however, the water does run out and must be removed to be refilled. Removal of the device for refilling creates an undesirable mess and requires clean up time. Additionally, stems of these devices may become clogged with soil and require cleaning. Furthermore, since plants must be regularly provided with needed amount of water and nutrients, they may sometimes experience damage when such nourishment cannot be provided by their owner who may be away for a time, for example. Consequently, a need exists for enabling a nearly automatic supply of nourishment in a convenient manner.

U.S. Pat. No. 2,837,869 to Victor H Chatten relates to a plant-watering device. The described plant-watering device includes a compact device of attractive appearance which can be used for moistening the soil in a small planter box or the like and which will supply the necessary amount or water without danger of flooding, or starving.

### SUMMARY OF THE INVENTION

In view of the foregoing disadvantages inherent in the known plant watering device art, the present disclosure provides a novel plant watering globe system. The general purpose of the present disclosure, which will be described subsequently in greater detail, is to provide an efficient and effective plant watering globe system.

A plant watering globe system is disclosed herein. The plant watering globe system includes a hollow bulb portion configured to provide a refillable water reservoir. The hollow bulb portion comprises an aperture positioned at a top-section and a hollow stake in fluid communication with and extending from a bottom-section of the hollow bulb portion. The hollow stake includes an open-end configured to be inserted in to the soil of a potted plant and the like for delivery of water from the hollow bulb portion. A funnel is further provided for refilling the hollow bulb portion with water via the aperture. The funnel may comprise a stem having a 45-degree bend. Additionally, a sealing plug is included for sealing the aperture of the hollow bulb portion.

A method of using a plant watering globe system is also disclosed herein. The method of using a plant watering globe system which preferably includes the steps of: step one, providing a hollow bulb portion comprising an aperture positioned at a top-section, a hollow stake in fluid communication with and extending from a bottom-section of the hollow bulb portion having an open-end, a funnel, and a sealing plug; step two, preparing soil for hosting the hollow stake and the hollow bulb portion; step three, inserting the hollow stake in the soil; step four, adding water to the hollow bulb portion; step five, refilling the hollow bulb portion with the water; step six, removing the hollow stake and the hollow bulb portion from the soil.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a plant watering globe system, constructed and operative according to the teachings of the present disclosure.

FIG. 1 is a perspective view of the plant watering globe system during an ‘in-use’ condition, according to an embodiment of the disclosure.

FIG. 2 is a perspective view of a hollow bulb portion of the plant watering globe system of FIG. 1, according to an embodiment of the present disclosure.

FIG. 3 is a perspective view of the hollow bulb portion of the plant watering globe system of FIG. 1, according to an embodiment of the present disclosure.

FIG. 4 is a perspective view of the plant watering globe system of FIG. 1, according to an embodiment of the present disclosure.

FIG. 5 is a kit view of the plant watering globe system of FIG. 1, according to an embodiment of the present disclosure.

FIG. 6 is a flow diagram illustrating a method of using a plant watering globe system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a plant watering device and more particularly to a plant watering globe system as used to improve the convenience of flower and plant maintenance. The plant watering globe system eliminates the mess and maintenance associated with standard plant-watering globes.

Generally, the plant watering globe system provides a kit that contains a hollow bulb portion having a sealable aperture on its top plane, allowing it to be refilled with water without removing the device from soil, and without disturbing the soil or roots due to such removal. Additionally, the kit includes a funnel and a sealing plug for the aperture of the hollow bulb portion. The hollow bulb portion may be heart shaped and includes a hollow stake that extends from a bottom-section of the hollow bulb portion. An open end is featured at an endpoint of the hollow stake. An aperture is featured on a top-section of the heart-shaped, hollow structure. The aperture features a rubber sleeve upon its edge, which protects the edges from cracking and chipping. A sealing plug which features a functional decorative extension, is also featured, and is used to seal the aperture at the top-section of the heart-shaped structure. A funnel is included and can be used to fill the hollow bulb portion with water as needed. The plant watering globe system distributes water upon instigation from oxygen released by dry soil.

In a preferred embodiment, the plant watering globe system includes a hollow bulb portion made of glass, and with a full-dimensional heart shape at its top point. The hollow bulb portion including a heart shape is of approximately four inches (4″) in maximum diameter by three inches (3″) in maximum height. At a top point of this heart shape is an aperture with an approximate diameter of five-eighths of one inch (⅝″). This aperture is lined with a rubber sleeve. A sealing plug, made of a pliant rubber-plastic amalgam material, applies to the aforementioned aperture, and is of a five-eighths of one-inch diameter by one-inch length (⅝″×1″). Extending from a bottom-section of the hollow bulb portion is a hollow stake of eight-inch length (8″). Through this length, the hollow stake narrows in diameter to its endpoint, and an open-end is featured at the endpoint.

A funnel, preferably produced of polyvinyl chloride (PVC), may be used to refill the hollow bulb portion. The funnel is approximately six inches (6″) in total length, features a two and one-half inch (2½″) diameter mouth that narrows to the stem. The stem is approximately four inches (4″) in total length, and at its midpoint extends at an approximate forty-five degree (45°) angle.

A method of use may be as follows: a user may prepare an intended location of use of the plant watering globe system by slightly puncturing a soil location, such as with a finger. The user may then simply insert the hollow stake of the device into the soil location. Water may then be added to the plant watering globe system using the funnel and the sealing plug may be applied. The plant watering globe system if needed can then be adjusted to ensure it remains in an upright position, and that the water can flow through the hollow stake without congestion or an excessive rate. The plant watering globe system may then remain in that same position throughout its time of use. A user may periodically check through the hollow bulb portion comprising translucent walls to determine need for refilling. Should a refill be needed, the user may simply remove the sealing plug, pour more water into the hollow bulb portion with use of the funnel, and then reapply the sealing plug.

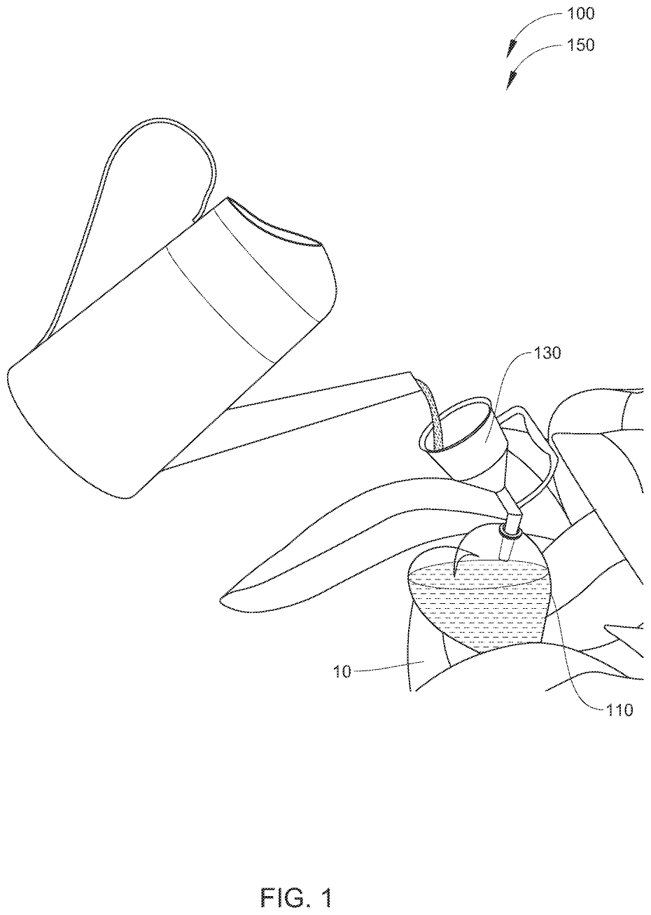

Referring now more specifically to the drawings by numerals of reference, there is shown in FIGS. 1-5, various views of a plant watering globe system 100.

FIG. 1 shows a plant watering globe system 100 during an ‘in-use’ condition 150, according to an embodiment of the present disclosure. Here, the plant watering globe system 100 may be beneficial for use by a user to water and maintain plants and flowers. As illustrated, the plant watering globe system 100 may include a hollow bulb portion 110 configured to provide a refillable water reservoir. The hollow bulb portion 110 comprises an aperture 112 positioned at a top-section 114 and a hollow stake 120 in fluid communication with and extending from a bottom-section 116 of the hollow bulb portion 110. The hollow stake 120 includes an open-end 122 configured to be inserted into the soil of a plant-hosting pot 10 for delivery of water from the hollow bulb portion 110. A funnel 130 is further provided for refilling the hollow bulb portion 110 with water via the aperture 112. The funnel 130 may comprise a stem having a 45-degree bend. Additionally, a sealing plug 140 is included for sealing the aperture 112 of the hollow bulb portion 110.

The plant watering globe system 100 may be inserted directly into the soil and/or a plant-hosting pot 10 of plants and flowers. The plant watering globe system 100 distributes water contents directly in to the soil. The plant watering globe system 100 distributes its water contents only as needed by the soil. The plant watering globe system 100 distributes water upon instigation from oxygen released by dry soil and maintains needed soil hydration. By providing hydration for extended periods, the plant watering globe system 100 reduces the need for frequent examination and manual hydration.

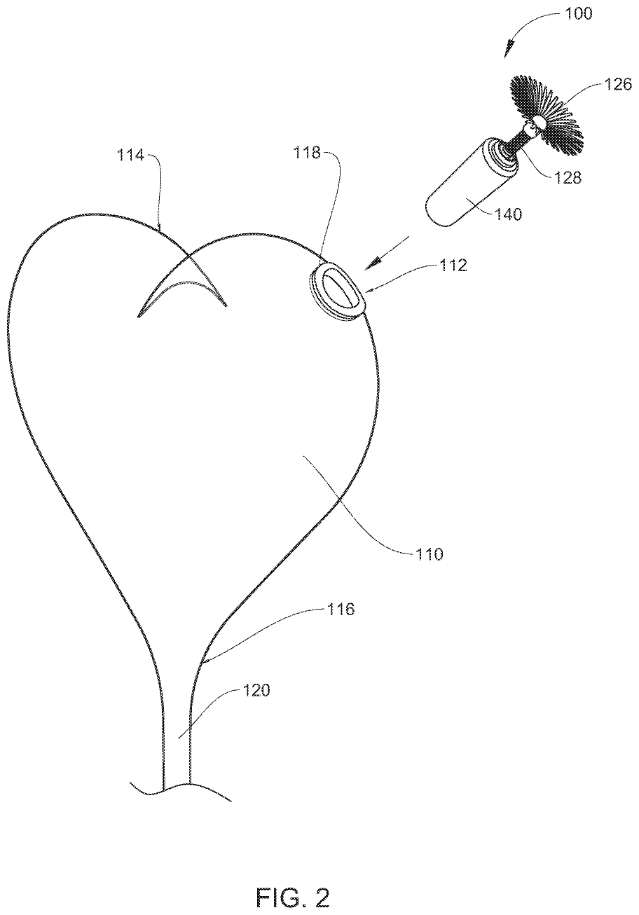

FIG. 2 is a perspective view of a hollow bulb portion 110 of the plant watering globe system 100 of FIG. 1, according to an embodiment of the present disclosure. As shown, the plant watering globe system 100 comprises the hollow bulb portion 110 including the aperture 112 positioned at the top-section 114. The aperture 112 comprises a rubber sleeve 118 extending along an edge of the aperture 112. The sealing plug 140 is sized and configured to fit within the aperture 112 and seal the aperture 112 when inserted. The sealing plug 140 comprises a cork-like shape. The sealing plug 140 of the plant watering globe system 100 when in contact with the rubber sleeve 118 of the plant watering globe system 100 prevents evaporation of the water contained within the hollow bulb portion 110. Further, when the sealing plug 140 of the plant watering globe system 100 is in contact with the rubber sleeve 118 of the plant watering globe system 100 this contact prevents contamination of the water and thereby protects the health of any plant receiving water from the plant watering globe system 100. Additionally, the sealing plug 140 may include a functional decorative extension 126. The functional decorative extension 126 is attached to the sealing plug 140 by a connector 128. The connector 128 may include a flexible or semi-rigid body. In certain versions, the connector 128 may include a spring, and this spring can facilitate movement of the functional decorative extension 126. In one embodiment, the hollow bulb portion 110 comprises a functional heart shape. The hollow bulb portion 110 may be made in various sizes, in various shapes and with various fluid volume capacities.

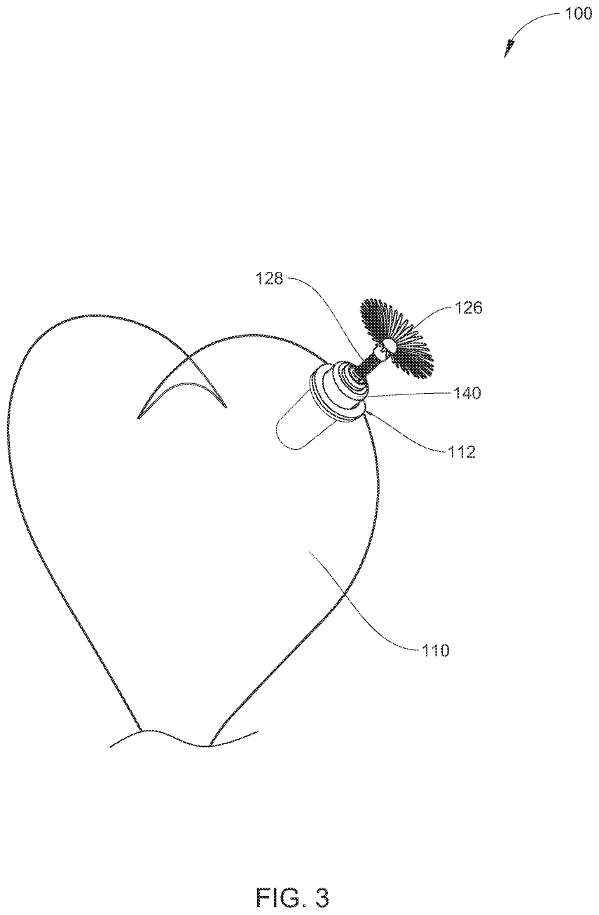

FIG. 3 is a perspective view of the hollow bulb portion 110 of the plant watering globe system 100 of FIG. 1, according to an embodiment of the present disclosure. As illustrated, the sealing plug 140 is sized and configured to fit within the aperture 112 and seal the aperture 112 when inserted. The sealing plug 140 of the plant watering globe system 100 may be made of various materials of adequate durability, such as but not limited to rubber, rubber-plastic amalgam, various plastics and synthetic cork. The aperture 112 includes the rubber sleeve 118 that prevents the edges of the aperture 112 from cracking or chipping. The aperture 112 allows for the hollow bulb portion 110 to be refilled without removing the device from the plant-hosting pot 10. By not requiring reinsertion after being refilled with water, the plant watering globe system 100 does not disrupt the roots of the plants and flowers it waters. As ordinary plant-watering globes generally require multiple attempts during initial application and multiple positional readjustments in order to achieve ideal operation, and then require a repeat of these procedures when they must be removed to refill, the plant watering globe system 100 eliminates the need to make additional attempts and readjustments after successful placement is first achieved.

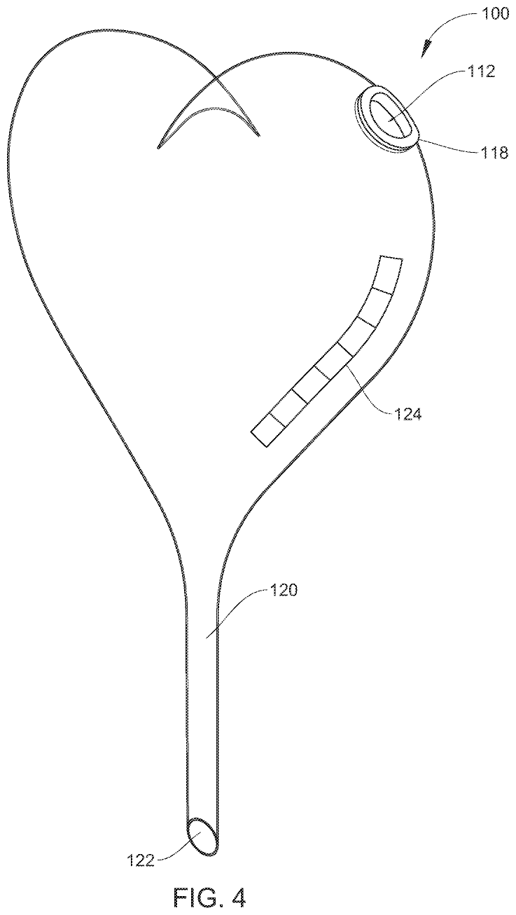

FIG. 4 is a perspective view of the plant watering globe system 100 of FIG. 1, according to an embodiment of the present disclosure. The hollow bulb portion 110 and the hollow stake 120 may be translucent and comprise a glass material. In other variations, the hollow bulb portion 110 and the hollow stake 120 may be non-translucent. The plant watering globe system 100 may be made of various materials that are translucent and ultraviolet (UV) resistant, including but not limited to glass, acrylic, polycarbonate (PC) plastics, and polyvinyl chloride (PVC). The plant watering globe system 100 can be produced in various translucent colors that allow adequate visibility so that the water volume of the device can be visually determined. The plant watering globe system 100 may also be made in opaque formats that still include a translucent portion to allow water volume to be visually determined. In certain embodiments, the hollow bulb portion 110 includes a gauge 124 for visually indicating water levels. The open-end 122 of the hollow stake 120 comprises a 45-degree angle. The 45-degree angle ensures the hollow stake 120 can be easily pushed into soil. In a preferred embodiment, the hollow stake 120 narrows in diameter towards the open-end 122. The hollow stake 120 comprises a length of approximately 8 inches. The length and diameter of the hollow stake 120 of the plant watering globe system 100 may vary.

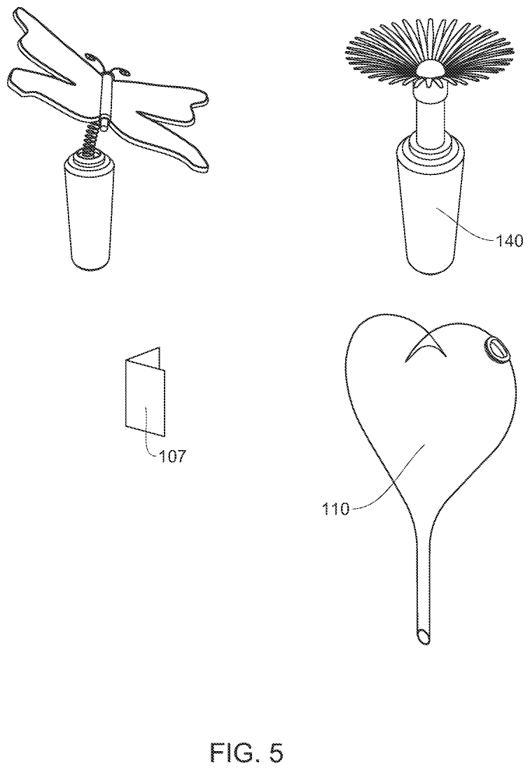

FIG. 5 is a kit view of the plant watering globe system 100 of FIG. 1, according to an embodiment of the present disclosure. According to one embodiment, the plant watering globe system 100 may be arranged as a kit. In particular, the plant watering globe system 100 may further include a set of instructions 107. The instructions 107 may detail functional relationships in relation to the structure of the plant watering globe system 100 such that the plant watering globe system 100 can be used, maintained, or the like, in a preferred manner.

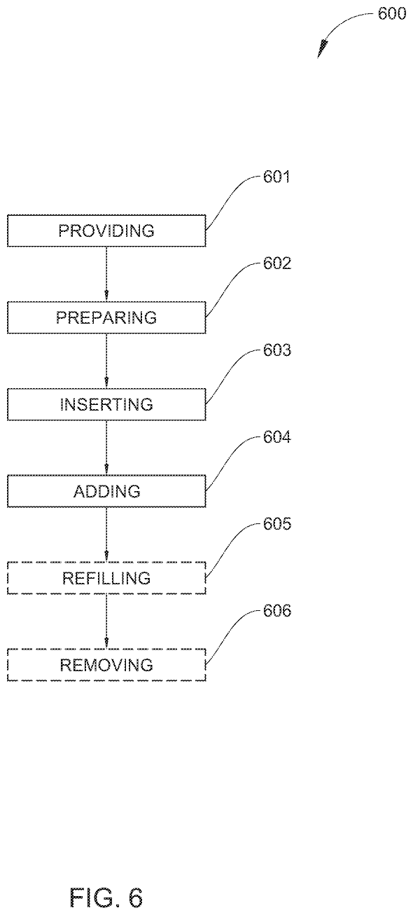

FIG. 6 is a flow diagram illustrating a method of using a plant watering globe system 100, according to an embodiment of the present disclosure. In particular, the method of using a plant watering globe system 600 may include one or more components or features of the plant watering globe system 100 as described above. As illustrated, the method of using a plant watering globe system 600 may include the steps of: step one 601, providing a hollow bulb portion 110 comprising an aperture 112 positioned at a top-section 114, a hollow stake 120 in fluid communication with and extending from a bottom-section 116 of the hollow bulb portion 110 having an open-end 122, a funnel 130, and a sealing plug 140; step two 602, preparing soil for hosting the hollow stake 120 and the hollow bulb portion 110; step three 603, inserting the hollow stake 120 in the soil; step four 604, adding water to the hollow bulb portion 110; step five 605, refilling the hollow bulb portion 110 with the water; step six 606, removing the hollow stake 120 and the hollow bulb portion 110 from the soil.

It should be noted that step five 605 and step six 606 are optional steps and may not be implemented in all cases. Optional steps of method of use 600 are illustrated using dotted lines in FIG. 6 so as to distinguish them from the other steps of method of use 600. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods of using a plant watering globe system 100, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A plant watering globe system, the plant watering globe system for hydration of plant soil comprising:
a hollow bulb portion configured to provide a refillable water reservoir, said hollow bulb portion comprising,
an aperture positioned at a top-section,
a hollow stake in fluid communication with and extending from a bottom-section of said hollow bulb portion having,
an open-end configured to be inserted in soil of a plant-hosting pot for delivery of water from said hollow bulb portion,
a funnel provided for refilling said hollow bulb portion with water via said aperture, and
a sealing plug for sealing said aperture of said hollow bulb portion.

2. The plant watering globe system of claim 1, wherein said hollow bulb portion comprises a functional heart shape.

3. The plant watering globe system of claim 1, wherein said aperture comprises a rubber sleeve extending along an edge of said aperture.

4. The plant watering globe system of claim 3, wherein said sealing plug is sized and configured to fit within said aperture and seal said aperture when inserted.

5. The plant watering globe system of claim 1, wherein said open-end of said hollow stake comprises a 45-degree angle.

6. The plant watering globe system of claim 5, wherein said hollow stake narrows in diameter towards said open-end.

7. The plant watering globe system of claim 6, wherein said hollow stake comprises a length of approximately 8 inches.

8. The plant watering globe system of claim 1, wherein said hollow bulb portion and said hollow stake are translucent.

9. The plant watering globe system of claim 8, wherein said hollow bulb portion and said hollow stake comprise a glass material.

10. The plant watering globe system of claim 1, wherein said hollow bulb portion and said hollow stake are non-translucent.

11. The plant watering globe system of claim 1, wherein said hollow bulb portion further includes a gauge for visually indicating water levels.

12. The plant watering globe system of claim 1, wherein said funnel comprises a stem having a 45-degree bend.

13. The plant watering globe system of claim 1, wherein said sealing plug comprises a cork-like shape.

14. The plant watering globe system of claim 13, wherein said sealing plug includes a functional decorative extension.

15. The plant watering globe system of claim 14, wherein said functional decorative extension is attached to said sealing plug by a connector.

16. The plant watering globe system of claim 15, wherein said connector is selected from the group including a spring and a rigid-connector.

17. A plant watering globe system, the plant watering globe system consisting of:
a hollow bulb portion configured to provide a refillable water reservoir, said hollow bulb portion comprising,
an aperture positioned at a top-section,
a hollow stake in fluid communication with and extending from a bottom-section of said hollow bulb portion having,
an open-end configured to be inserted in soil of a plant-hosting pot for delivery of water from said hollow bulb portion,
a funnel provided for refilling said hollow bulb portion with water via said aperture, and
a sealing plug for sealing said aperture of said hollow bulb portion;
wherein said hollow bulb portion comprises a functional heart shape;
wherein said aperture comprises a rubber sleeve extending along an edge of said aperture;
wherein said sealing plug is sized and configured to fit within said aperture and seal said aperture when inserted;
wherein said open-end of said hollow stake comprises a 45-degree angle;
wherein said hollow stake narrows in diameter towards said open-end;
wherein said hollow stake comprises a length of approximately 8 inches;
wherein said hollow bulb portion and said hollow stake are translucent;
wherein said hollow bulb portion and said hollow stake comprise a glass material;
wherein said funnel comprises a stem having a 45-degree bend;
wherein said sealing plug comprises a cork-like shape;
wherein said sealing plug includes a functional decorative extension;
wherein said functional decorative extension is attached to said sealing plug by a connector; and
wherein said connector is selected from the group including a spring and a rigid-connector.

18. The plant watering globe system of claim 17, further comprising set of instructions; and
wherein the plant watering globe system is arranged as a kit.

19. A method of using a plant watering globe system, the method comprising the steps of:
providing a hollow bulb portion configured to provide a refillable water reservoir, said hollow bulb portion comprising,
an aperture positioned at a top-section,
a hollow stake in fluid communication with and extending from a bottom-section of said hollow bulb portion having,
an open-end configured to be inserted in soil of a plant-hosting pot for delivery of water from said hollow bulb portion,
a funnel provided for refilling said hollow bulb portion with water via said aperture, and
a sealing plug for sealing said aperture of said hollow bulb portion;
preparing soil for hosting said hollow stake and said hollow bulb portion;
inserting said hollow stake in said soil; and
adding water to said hollow bulb portion.

20. The method of claim 19, further comprising the steps of:
refilling said hollow bulb portion with said water; and
removing said hollow stake and said hollow bulb portion from said soil.
